(19) United States
(12) Patent Application Publication
(10) Pub. No.: US 2011/0080799 A1
(43) Pub. Date: Apr. 7, 2011

(54) FLUID PROCESSING SYSTEM

(76) Inventor: Cheng San Lin, Kaohsiung (TW)

(21) Appl. No.: 12/830,315

(22) Filed: Jul. 3, 2010

(30) Foreign Application Priority Data
Oct. 6, 2009 (TW) 098218366

(51) Int. Cl. B01F 13/08; B01F 15/06

(52) U.S. Cl. 366/147; 366/273

(57) ABSTRACT

A fluid processing system includes a first tube having a conductor disposed in the first tube, and a flow path disposed in the fluid processing system; the conductor is capable of being connected to a power supply unit such that when the power supply unit is turned on, the conductor is magnetized, and the fluid is refined by magnetic lines of force. An auger is disposed on an outer sidewall of the conductor to form a screw. Therefore, when the fluid enters into the fluid processing system, the fluid flows along the auger such that the time the fluid stays in the first tube and the screw is increased, and the fluid is thus processed by the magnetic field lines for a longer period of time

### BACKGROUND OF THE INVENTION

1. Field of the Invention

The present invention relates to a fluid processing system, and more particularly to a fluid processing system that increases the dissolving efficiency of the solute to improve an extraction efficiency of the fluid.

2. Description of the Related Art

Fluids are typically used in a wide variety processes, such as for cooling, cleaning, manufacturing, etc. However, an increasing number of natural materials are finding use in daily life, such as for diet or household products.

Most of these natural materials exist in a fluid (or liquid) state. A fluid (such as an ointment, paste, glue, juice, jells or the like) will typically comprise a solute that is dissolvable or micro-dissolvable with water (acting as the solvent). The dissolving rate of the solute within the solvent is primarily related to the particle size of the solute, the temperature of the solvent, etc. Additional external physical conditions can be applied to increase the dissolving efficiency of the solute within the solvent. However, if no such additional physical conditions are applied the dissolving rate is relatively slower.

Therefore, it is desirable to provide a fluid processing system to mitigate and/or obviate the aforementioned problems.

### SUMMARY OF THE INVENTION

An objective of the present invention is to provide a fluid processing system.

In order to achieve the above-mentioned objectives the fluid processing system comprises a first tube having a conductor disposed in the first tube, and a flow path disposed in the fluid processing system; the conductor is capable of being connected to a power supply unit such that when the power supply unit is turned on, the conductor is magnetized, and the fluid is refined by magnetic lines of force; and a second tube being coaxial with the first tube and distanced by a gap.

After the power supply unit is turned on, the conductor of the screw is magnetized. Therefore, when the fluid enters into the fluid processing system, the fluid is thus processed by the magnetic field lines for a longer period of time. During processing, the solvent is refined by the fluid processing system, and the refined solvent is able to penetrate into the surface of particles of kappaphycus to increase the dissolving efficiency of the solvent, and even to improve the extraction efficiency of the solute from the fluid. Therefore, with the fluid refining process of the present invention, the extracted solute from the refined fluid is suitable for dietary purposes, supplements, or other products.

Other objects, advantages, and novel features of the invention will become more apparent from the following detailed description when taken in conjunction with the accompanying drawings.

### BRIEF DESCRIPTION OF THE DRAWINGS

FIG. 1 illustrates an embodiment of the present invention.

FIG. 2 shows usage of an embodiment of the present invention.

### DETAILED DESCRIPTION OF THE PREFERRED EMBODIMENT

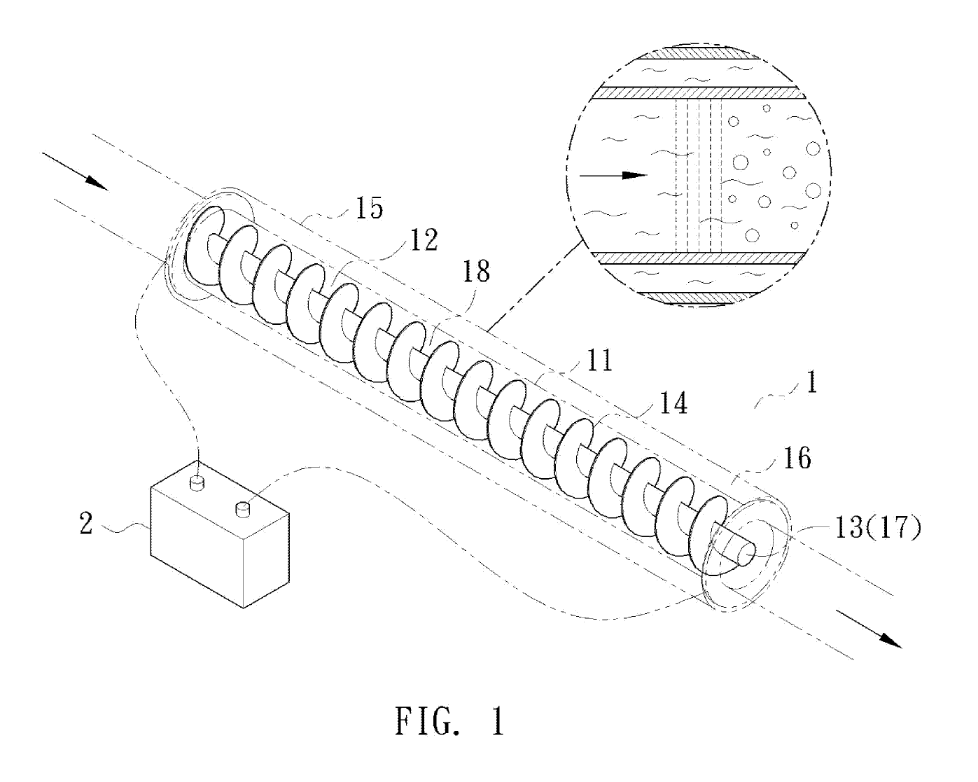

Please refer to FIG. 1. An embodiment fluid processing system 1 of the present invention comprises a first tube 11; the first tube 11 has a conductor 13 disposed in the first tube 11, and a flow path 18 is disposed in the fluid processing system 1. Since the conductor 13 is capable of being connected to a power supply unit 2, when a fluid enters into the flow path 18 of the fluid processing system 1 and makes contact with the conductor 13, once the power supply unit 2 turned on, the conductor 13 is magnetized, and the solvent in the fluid is forced to penetrate into and make contact with the solute (the main ingredient or nutrition of the fluid) by magnetic lines of force to generate a thinner (less viscous) fluid. A second tube 15 is jacketed onto and is coaxial with the first tube 11, and a gap 16 is formed between the first tube 11 and the second tube 15. Furthermore, the gap 16 is filled with cooling water to reduce the temperature of the fluid processing system 1 after the power is turned on.

In a preferred embodiment of the fluid processing system, an auger 14 is disposed on an outer sidewall of the conductor 13 to form a screw 12, and a shaft 17 of the screw 12 is the conductor 13. Since the conductor 13 is connected to the power supply unit 2, after the power supply unit 2 is turned on, the conductor 13 of the screw 12 is magnetized. Therefore, when the fluid enters into the fluid processing system 1, the fluid flows along the auger 14 such that the time the fluid stays in the first tube 11 and the screw 12 is increased, and the fluid is thus processed by the magnetic field lines for a longer period of time.

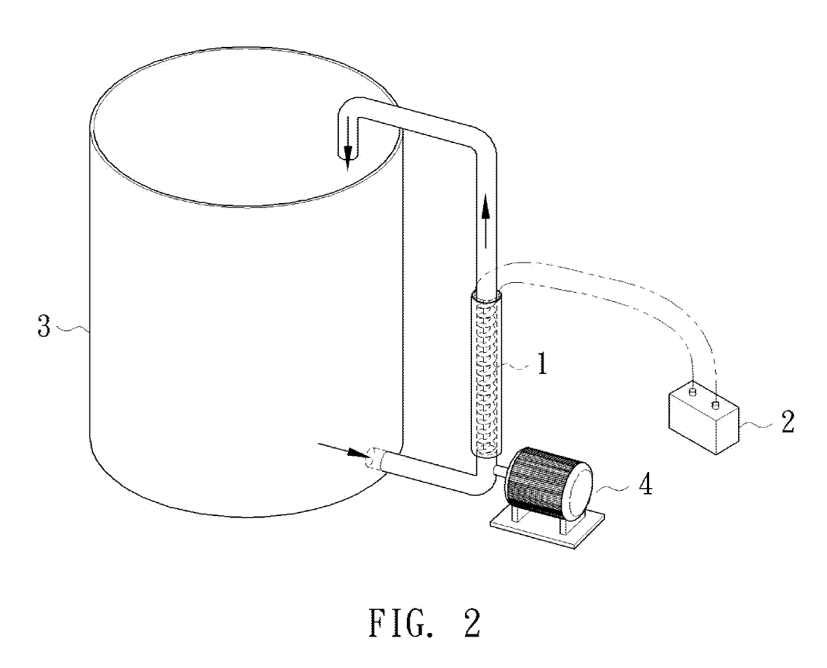

As shown in FIG. 2, the fluid processing system 1 may be connected to another apparatus. In this embodiment, the solute is kappaphycus, and the kappaphycus is mixed with a solvent as a fluid. The mixed fluid is stored in a tank 3, and a pump 4 is used to draw the fluid into the fluid processing system 1. During processing, the solvent is refined by the fluid processing system 1, and the refined solvent is able to penetrate into the surface of particles of kappaphycus to increase the dissolving efficiency of the solvent, and even to improve the extraction efficiency of the solute from the fluid. Therefore, with the fluid refining process of the present invention, the extracted solute from the refined fluid is suitable for dietary purposes, supplements, or other products.

Although the present invention has been explained in relation to its preferred embodiment, it is to be understood that many other possible modifications and variations can be made without departing from the spirit and scope of the invention as hereinafter claimed.

What is claimed is:

1. A fluid processing system comprising:
a first tube having a conductor disposed in the first tube, and a flow path disposed in the fluid processing system; wherein the conductor is capable of being connected to a power supply unit such that when the power supply unit is turned on, the conductor is magnetized, and the fluid is refined by magnetic lines of force.

2. The fluid processing system as claimed in claim 1 further comprising a second tube, the second tube being coaxial with the first tube, and a gap is between the first tube and the second tube.

3. The fluid processing system as claimed in claim 1, wherein an auger is disposed on an outer sidewall of the conductor.

4. The fluid processing system as claimed in claim 2, wherein the gap can be filled with cooling water to reduce the temperature of the fluid processing system after the power is turned on.
